(19) United States
(12) Patent Application Publication
(10) Pub. No.: US 2026/0251847 A1
(43) Pub. Date: Aug. 27, 2026

(54) PHOTONIC STRUCTURES INCLUDING AIR GAPS BETWEEN WAVEGUIDE CORES

(71) Applicant: GlobalFoundries U.S. Inc., Malta, NY (US)

(72) Inventors: Avijit Chatterjee, Bangalore (IN); Riddhi Nandi, Bangalore (IN); Anupam Dutta, Bangalore (IN)

(21) Appl. No.: 19/060,882

(22) Filed: Feb. 24, 2025

(51) Int. Cl. G02B 6/122

(52) U.S. Cl. CPC G02B 6/1228

(57) ABSTRACT

Structures for a photonic chip that include a waveguide and methods of forming such structures. The structure comprises a first waveguide core, a second waveguide core including a section that overlies a section of the first waveguide core, and a dielectric layer between the first and second waveguide cores. The dielectric layer including air gaps between the sections of the first and second waveguide cores.

### BACKGROUND

This disclosure relates to photonic chips and, more specifically, to structures for a photonic chip that include a waveguide core and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

Waveguide cores are used on the photonic chip as building blocks to construct photonic components and as optical communication paths to connect the photonic components. Waveguides include low-index cladding that surrounds the waveguide core to provide a contrast in refractive index for confining and guiding light on the photonic chip. Conventional waveguides may suffer from low optical confinement and high propagation loss.

Improved structures for a photonic chip that include a waveguide core and methods of forming such structures are needed.

### SUMMARY

In an embodiment of the invention, a structure for a photonic chip is provided. The structure comprises a first waveguide core including a section, a second waveguide core including a section that overlies the section of the first waveguide core, and a dielectric layer between the first waveguide core and the second waveguide core. The dielectric layer includes a plurality of air gaps between the section of the first waveguide core and the section of the second waveguide core.

In an embodiment of the invention, a method of forming a structure for a photonic chip is provided. The method comprises forming a first waveguide core that includes a section, forming a dielectric layer, forming a plurality of air gaps in the dielectric layer, and forming a second waveguide core that includes a section overlying the section of the first waveguide core. The dielectric layer is positioned between the first waveguide core and the second waveguide core, and the air gaps are positioned between the section of the first waveguide core and the section of the second waveguide core.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 2 is a cross-sectional view taken generally along line 2-2 in FIG. 1.

FIG. 2A is a cross-sectional view taken generally along line 2A-2A in FIG. 1.

FIG. 2B is a cross-sectional view taken generally along line 2B-2B in FIG. 1.

FIG. 3 is a top view of the structure at a fabrication stage of the processing method subsequent to FIG. 1.

FIG. 4 is a cross-sectional view taken generally along line 4-4 in FIG. 3.

FIG. 4A is a cross-sectional view taken generally along line 4A-4A in FIG. 3.

FIG. 4B is a cross-sectional view taken generally along line 4B-4B in FIG. 3.

FIG. 5 is a top view of the structure at a fabrication stage of the processing method subsequent to FIG. 3.

FIG. 6 is a cross-sectional view taken generally along line 6-6 in FIG. 5.

FIG. 6A is a cross-sectional view taken generally along line 6A-6A in FIG. 5.

FIG. 6B is a cross-sectional view taken generally along line 6B-6B in FIG. 5.

FIGS. 7, 7A, 7B are cross-sectional views of the structure at a fabrication stage of the processing method subsequent to FIGS. 6, 6A, 6B.

FIG. 8 is a cross-sectional view of a structure in accordance with alternative embodiments of the invention.

FIG. 9 is a cross-sectional view of a structure in accordance with alternative embodiments of the invention.

FIG. 10 is a top view of a structure in accordance with alternative embodiments of the invention.

### DETAILED DESCRIPTION

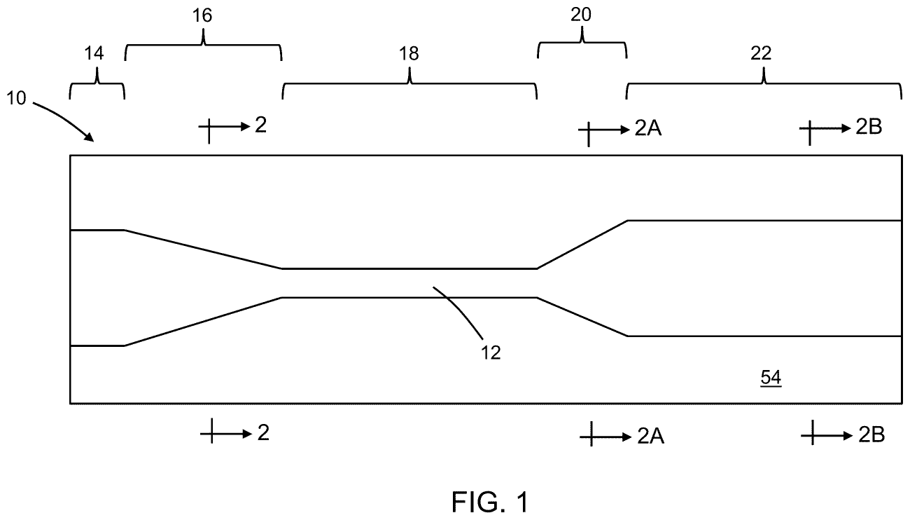

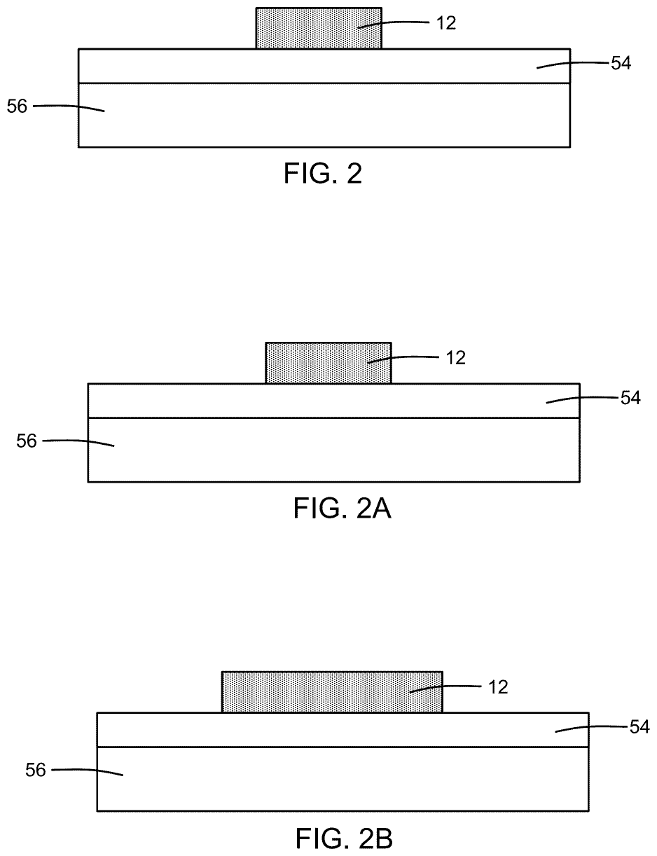

With reference to FIGS. 1, 2, 2A, 2B and in accordance with embodiments of the invention, a structure 10 for a photonic chip includes a waveguide core 12 that is positioned on, and above, a dielectric layer 54 and a semiconductor substrate 56. In an embodiment, the dielectric layer 54 may be comprised of a dielectric material, such as an oxide (e.g., silicon dioxide), and the semiconductor substrate 56 may be comprised of a semiconductor material, such as single-crystal silicon. In an embodiment, the dielectric layer 54 may be a buried oxide layer of a silicon-on-insulator substrate. The dielectric layer 54 may provide low-index cladding that optically isolates the waveguide core 12 from the semiconductor substrate 56.

The waveguide core 12 may include multiple sections 14, 16, 18, 20, 22. The section 16, which may be tapered, is arranged along the length of the waveguide core 12 between the section 14 and the section 18. The section 18, which may be narrower in width dimension than the section 14, may connect the section 16 to the section 20. The section 20, which may be tapered oppositely to the tapering of the section 16, is arranged along the length of the waveguide core 12 between the section 18 and the section 22. The section 14 and the section 22 may be coupled to other photonic components of the photonic integrated circuit.

In an embodiment, the waveguide core 12 may be comprised of a material having a refractive index that is greater than the refractive index of silicon dioxide. In an embodiment, the waveguide core 12 may be comprised of a semiconductor material, such as single-crystal silicon, amorphous silicon, or polysilicon. In an alternative embodiment, the waveguide core 12 may be comprised of a dielectric material, such as silicon nitride, silicon oxynitride, or aluminum nitride. In alternative embodiments, other materials, such as a III-V compound semiconductor, may be used to form the waveguide core 12.

In an embodiment, the waveguide core 12 may be formed by patterning a layer comprised of its constituent material with lithography and etching processes. In an embodiment, an etch mask may be formed by a lithography process over the layer, and unmasked sections of the layer may be etched and removed with an etching process. In an embodiment, the waveguide core 12 may be formed by patterning the semiconductor material (e.g., single-crystal silicon) of the device layer of a silicon-on-insulator substrate. In an embodiment, the waveguide core 12 may be formed by patterning a deposited layer comprised of its constituent material.

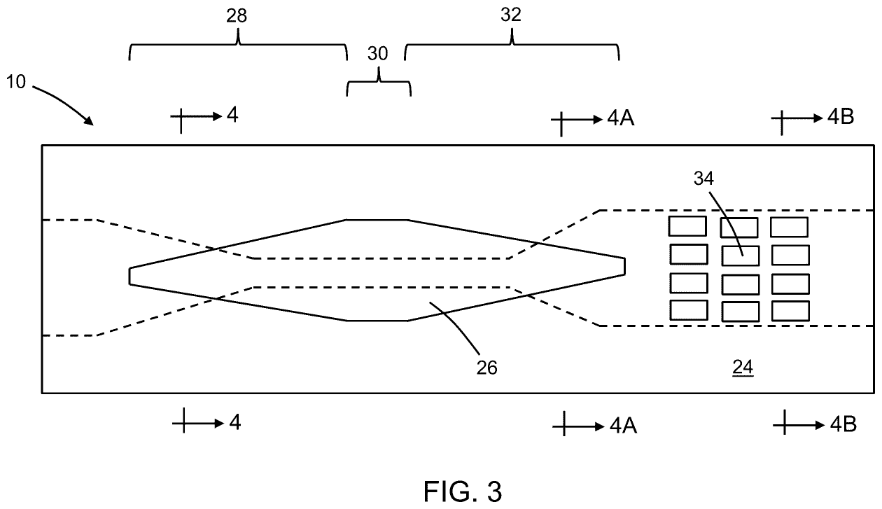

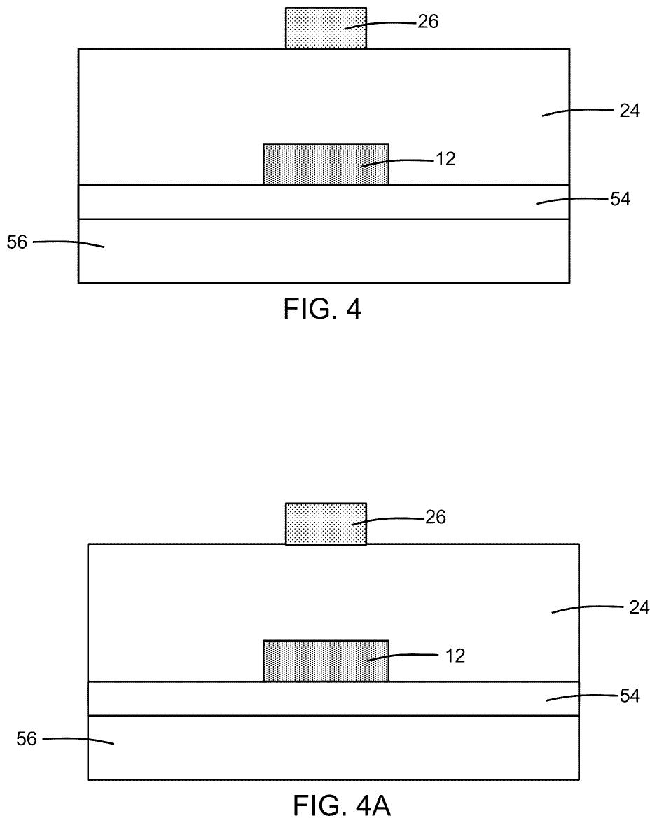

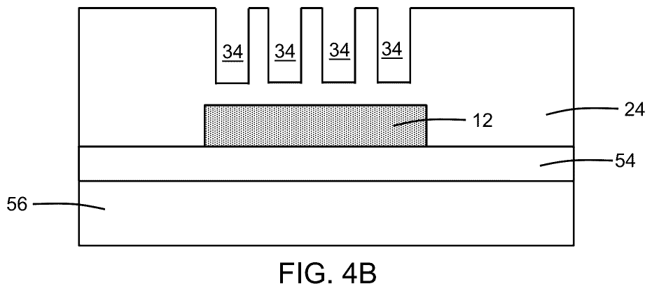

With reference to FIGS. 3, 4, 4A, 4B in which like reference numerals refer to like features in FIGS. 1, 2, 2A, 2B and at a subsequent fabrication stage, a dielectric layer 24 may be formed over the waveguide core 12. The dielectric layer 24 may be comprised of a dielectric material, such as an oxide (e.g., silicon dioxide), having a refractive index that is less than the refractive index of the material constituting the waveguide core 12.

A waveguide core 26 may be formed on the dielectric layer 24. The waveguide core 26 may include multiple sections 28, 30, 32. The section 30 is arranged along the length of the waveguide core 26 between the section 28, which may be tapered, and the section 32, which may be tapered in an opposite direction from the tapering of the section 28. The section 28 terminates one end of the waveguide core 26, and the section 32 terminates an opposite end of the waveguide core 26. The section 28 of the waveguide core 26 may overlap with the section 16 of the waveguide core 12. The section 32 of the waveguide core 26 may overlap with the section 20 of the waveguide core 12.

In an embodiment, the waveguide core 26 may be comprised of a material having a refractive index that is greater than the refractive index of silicon dioxide. In an embodiment, the waveguide core 26 may be comprised of a material having a refractive index that differs from the refractive index of the material of the waveguide core 12. In an embodiment, the waveguide core 26 may be comprised of a dielectric material, such as silicon nitride, silicon oxynitride, or aluminum nitride. In an alternative embodiment, the waveguide core 26 may be comprised of a semiconductor material, such as amorphous silicon or polysilicon. In alternative embodiments, other materials, such as a III-V compound semiconductor, may be used to form the waveguide core 26.

In an embodiment, the waveguide core 26 may be formed by patterning a layer comprised of its constituent material with lithography and etching processes. In an embodiment, an etch mask may be formed by a lithography process over the layer, and unmasked sections of the layer may be etched and removed with an etching process. In an embodiment, the waveguide core 26 may be formed by patterning a deposited layer comprised of its constituent material.

Cavities 34 may be formed in the dielectric layer 24 at locations overlying the section 22 of the waveguide core 12. In an embodiment, the bottoms of the cavities 34 may be located above the waveguide core 12. In an embodiment, the cavities 34 may be formed by patterning the dielectric layer 24 with lithography and etching processes. In an embodiment, an etch mask may be formed by a lithography process over the layer, and unmasked sections of the layer may be etched and removed with an etching process to form the cavities 34. In an embodiment, the cavities 34 may be arranged in a pattern. In an embodiment, the cavities 34 may be arranged in the rows and columns of a two-dimensional array.

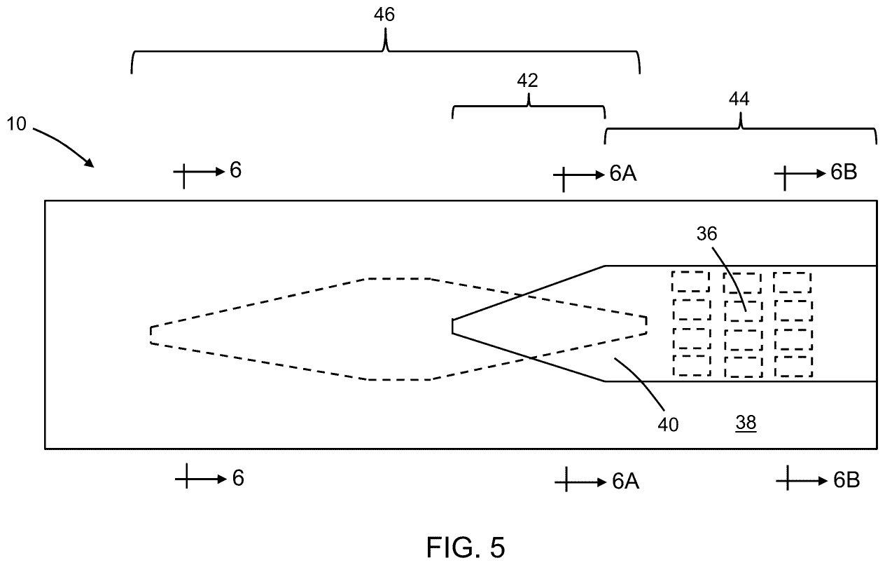

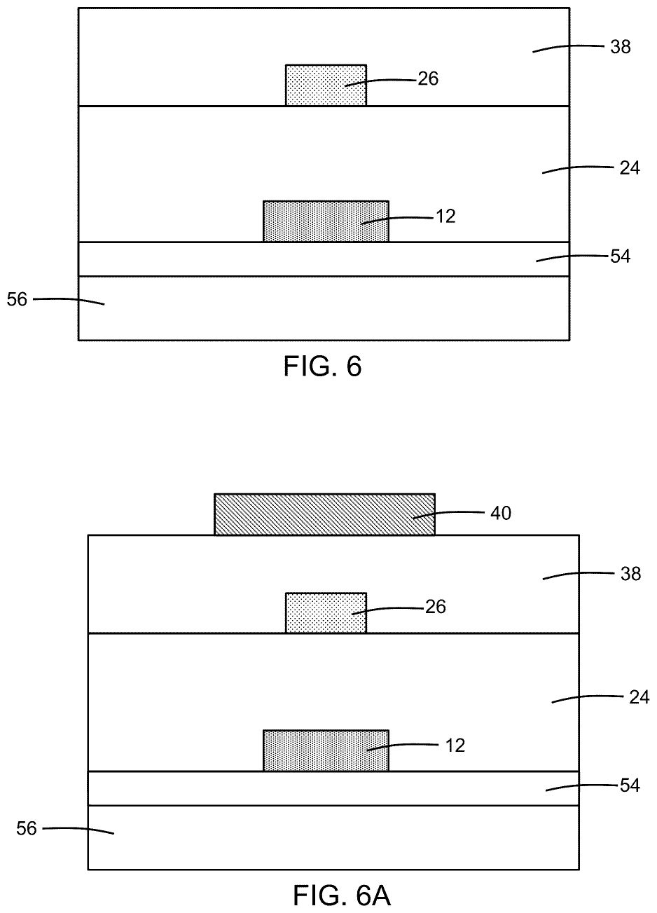

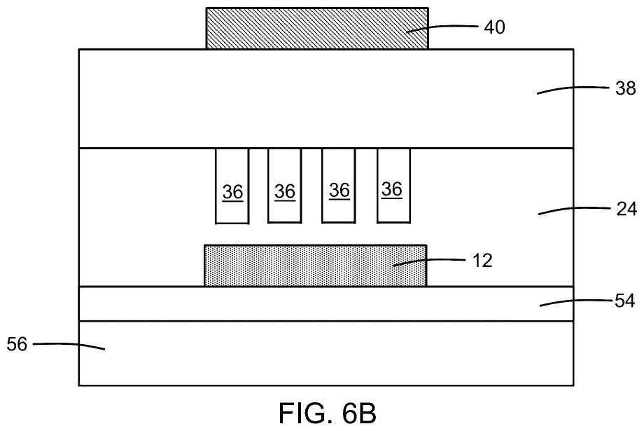

With reference to FIGS. 5, 6, 6A, 6B in which like reference numerals refer to like features in FIGS. 3, 4, 4A, 4B and at a subsequent fabrication stage, a dielectric layer 38 may be formed over the waveguide core 26. The dielectric layer 38 may be comprised of a dielectric material, such as an oxide (e.g., silicon dioxide), having a refractive index that is less than the refractive index of the material constituting the waveguide core 26.

The dielectric layer 38 may close the cavities 34 to form air gaps 36 that are embedded within the dielectric layer 24. The air gaps 36 are unfilled by solid dielectric material and are instead filled by a gas. The air gaps 36 may be characterized by a permittivity or dielectric constant of near unity (i.e., vacuum permittivity), which is less than the permittivity of the dielectric material of the dielectric layer 24. The air gaps 36 may be filled by atmospheric air at or near atmospheric pressure, may be filled by another gas at or near atmospheric pressure, or may contain atmospheric air or another gas at a sub-atmospheric pressure (e.g., a partial vacuum).

A waveguide core 40 may be formed on the dielectric layer 38. The waveguide core 40 may include a section 42 and a section 44 that is connected to the section 42. The section 42, which may be tapered, overlaps with the section 32 of the waveguide core 26. The section 44 of the waveguide core 40 overlaps with the air gaps 36 and also overlaps with the section 22 of the waveguide core 12. The air gaps 36 are positioned between the overlying section 44 of the waveguide core 40 and the underlying section 22 of the waveguide core 12.

The section 16 of the waveguide core 12, the sections 28, 30, and 32 of the waveguide core 26, and the section 42 of the waveguide core 40 may represent an optical coupler 46 that can split light into portions, as well as function as an elevator that changes the level of a split portion of the light such that the section 44 of the waveguide core 40 can overlie the section 22 of the waveguide core 12. For example, light propagating in the waveguide core 12 toward the optical coupler 46 may be split such that a portion of the light is transferred by the optical coupler 46 upwardly to the waveguide core 40 for propagation away from the optical coupler 46. Another portion of the light continues to propagate in the waveguide core 12 away from the optical coupler 46. The optical coupler 46 may alternatively function to combine light that is propagating toward the optical coupler 46 in the waveguide core 12 and in the waveguide core 40, and output the combined light to propagate in the waveguide core 12 away from the optical coupler 46.

In an embodiment, the waveguide core 40 may be comprised of a material having a refractive index that is greater than the refractive index of silicon dioxide. In an embodiment, the waveguide core 40 may be comprised of a material having a refractive index that is that same as the refractive index of the material of the waveguide core 26. In an embodiment, the waveguide core 40 may be comprised of a dielectric material, such as silicon nitride, silicon oxynitride, or aluminum nitride. In an alternative embodiment, the waveguide core 40 may be comprised of a semiconductor material, such as amorphous silicon or polysilicon. In alternative embodiments, other materials, such as a III-V compound semiconductor, may be used to form the waveguide core 40.

In an embodiment, the waveguide core 40 may be formed by patterning a layer comprised of its constituent material with lithography and etching processes. In an embodiment, an etch mask may be formed by a lithography process over the layer, and unmasked sections of the layer may be etched and removed with an etching process. In an embodiment, the waveguide core 40 may be formed by patterning a deposited layer comprised of its constituent material.

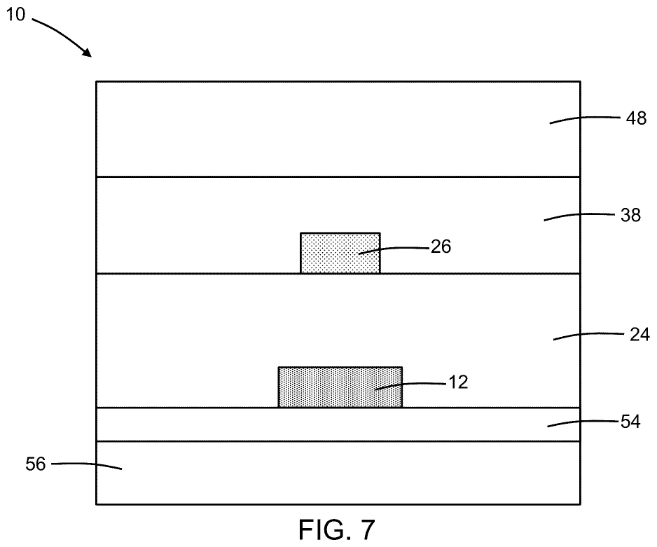

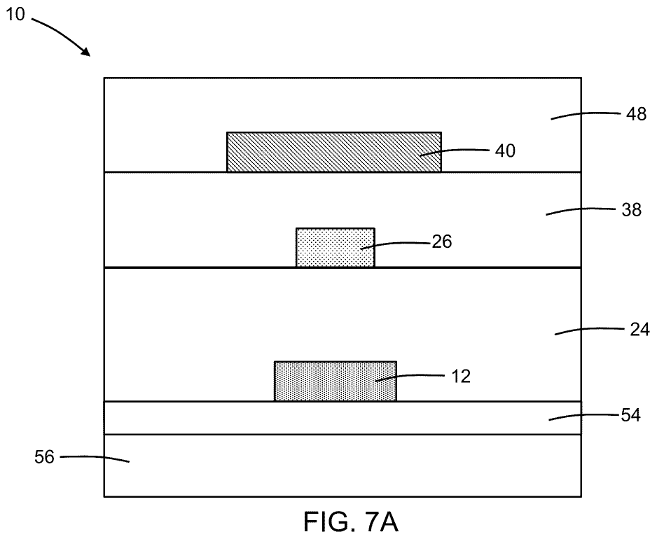

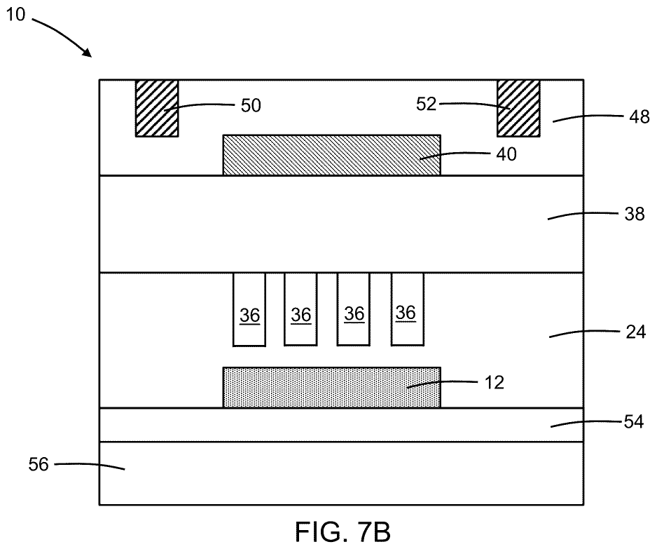

With reference to FIGS. 7, 7A, 7B in which like reference numerals refer to like features in FIGS. 5, 6, 6A, 6B and at a subsequent fabrication stage, a dielectric layer 48 may be formed over the waveguide core 40. The dielectric layer 48 may be comprised of a dielectric material, such as an oxide (e.g., silicon dioxide), having a refractive index that is less than the refractive index of the material constituting the waveguide core 40.

A heater 50 and a heater 52 may be formed in the dielectric layer 48. The section 44 of the waveguide core 40 may be positioned in a lateral direction between the heater 50 and the heater 52 to provide a thermo-optic phase shifter. In an embodiment, the heaters 50, 52 may be comprised of a conductor, such as a metal or doped polysilicon, and may be coupled to a power source. In an embodiment, the dielectric layer 48 may be patterned to form trenches that are subsequently filled by portions of the conductor to provide the heaters 50, 52.

In use, light entering the optical coupler 46 in the section 14 of the waveguide core 12 may be split such that a portion of the optical power is transferred from the section 16 of the waveguide core 12 to the section 28 of the waveguide core 26. A non-split portion of the light continues to propagate in the sections 18, 20, 22 of the waveguide core 12. The split portion of the light is transferred by the section 32 of the waveguide core 26 to the section 42 of the waveguide core 40 and, after the elevation change, propagates away from the optical coupler 46 in the section 44 of the waveguide core 40.

Heat generated by the heaters 50, 52 is transferred to the section 42 of the waveguide core 40 through respective heat transfer paths. The temperature of the section 44 of the waveguide core 40 is elevated by the transferred heat. The temperature increase experienced by the waveguide core 40 may be effective to change the refractive index of the material constituting the waveguide core 40 and to thereby alter the phase of light propagating in the heated section 44 of the waveguide core 40.

The air gaps 36 provide thermal isolation between the section 22 of the waveguide core 12 and the section 44 of the waveguide core 40 by reducing the transfer of heat from the heaters 50, 52 to the section 22 of the waveguide core 12. The air gaps 36 may also function to improve the efficiency of the transfer of heat to the section 44 of the waveguide core 40. The air gaps 36 also enhance the optical isolation between the section 22 of the waveguide core 12 and the section 44 of the waveguide core 40, which may permit a reduction in their vertical spacing without introducing crosstalk.

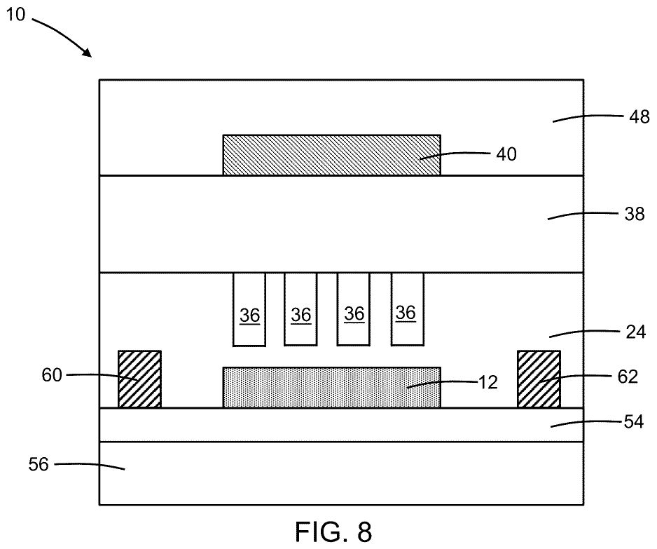

With reference to FIG. 8 and in accordance with alternative embodiments, a heater 60 and a heater 62 may be formed in the dielectric layer 24 adjacent to the section 22 of the waveguide core 12. The section 22 of the waveguide core 12 is positioned in a lateral direction between the heater 60 and the heater 62. The section 22 of the waveguide core 12 receives heat transferred from the heater 60 and the heater 62, and the air gaps 36 thermally isolate the section 44 of the waveguide core 40. In an embodiment, the heaters 60, 62 may be comprised of a conductor, such as a metal or doped polysilicon, and may be coupled to a power source.

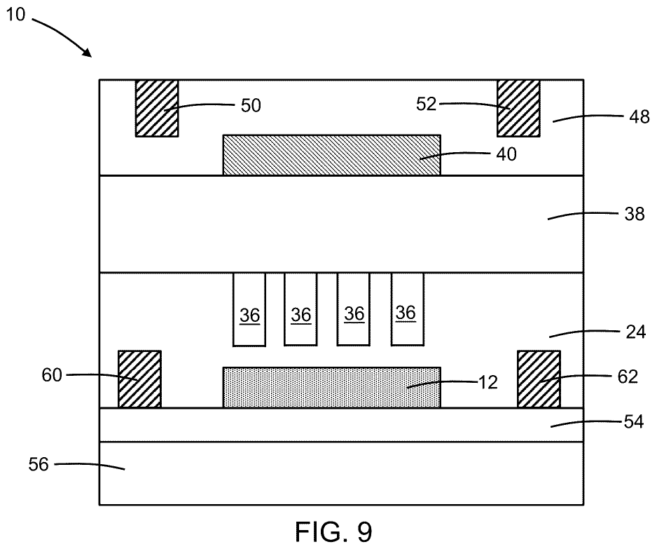

With reference to FIG. 9 and in accordance with alternative embodiments, the heaters 50, 52 may be formed in the dielectric layer 48 adjacent to the section 44 of the waveguide core 40, and the heaters 60, 62 may be formed in the dielectric layer 24 adjacent to the section 22 of the waveguide core 12. The air gaps 36 may provide thermal isolation that limits heat transfer from the heaters 50, 52 to the section 22 of the waveguide core 12 and that limits heat transfer from the heaters 60, 62 to the section 44 of the waveguide core 40, which promotes independent temperature control of the section 22 of the waveguide core 12 and the section 44 of the waveguide core 40.

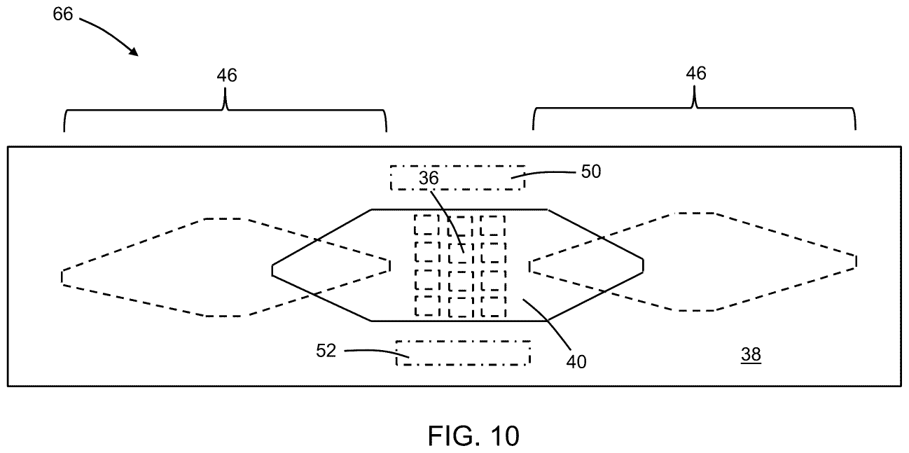

With reference to FIG. 10 and in accordance with alternative embodiments, a Mach-Zehnder interferometer 66 includes an instance of the optical coupler 46 representing an input optical coupler, an instance of the optical coupler 46 representing an output optical coupler, and portions of the waveguide core 12 and the waveguide core 40 represent vertically-stacked arms that are separately between from the optical couplers 46. The air gaps 36 and the heaters 50, 52 are positioned along the length of the waveguide core 12 and the waveguide core 40 between the optical couplers 46. The heaters 50, 52 may be configured to preferentially heat a portion of the waveguide core 40, without significantly heating the waveguide core 12, in order to generate a phase difference between the light propagating in the different arms of the Mach-Zehnder interferometer 66.

The stacking of the waveguide core 12 and the waveguide core 40 between the optical couplers 46, which is enabled by the air gaps 36 supplying thermal isolation and optical isolation between the stacked portions of the waveguide core 12 and the waveguide core 40, significantly reduces the size of the Mach-Zehnder interferometer 66. The thermo-optic phase shifter that includes the heaters 50, 52 may be used to generate a phase difference between the light propagating in the different arms of the Mach-Zehnder interferometer 66. Light may be combined by the optical coupler 46 representing the output optical coupler, and the light may be modulated because of the occurrence of either constructive interference or destructive interference contingent upon the presence or absence of the phase shift.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a direction or a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or “directly contacting” another feature if intervening features are absent. A feature may be “indirectly on” or in “indirect contact” with another feature if at least one intervening feature is present. Different features may “overlap” if a feature extends over, and covers a part of, another feature. A feature may “overlie” another feature if a feature is positioned “over” another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a photonic chip, the structure comprising:
a first waveguide core including a first section;
a second waveguide core including a first section that overlies the first section of the first waveguide core; and
a dielectric layer between the first waveguide core and the second waveguide core, the dielectric layer including a plurality of air gaps between the first section of the first waveguide core and the first section of the second waveguide core.

2. The structure of claim 1 wherein the first section of the second waveguide core overlaps with the first section of the first waveguide core.

3. The structure of claim 1 further comprising:
a first heater positioned adjacent to the first section of the second waveguide core.

4. The structure of claim 3 further comprising:
a second heater positioned adjacent to the first section of the first waveguide core.

5. The structure of claim 3 further comprising:
a second heater positioned adjacent to the first section of the second waveguide core,
wherein the first section of the second waveguide core is laterally positioned between the first heater and the second heater.

6. The structure of claim 1 further comprising:
a first heater positioned adjacent to the first section of the first waveguide core.

7. The structure of claim 6 further comprising:
a second heater positioned adjacent to the first section of the first waveguide core,
wherein the first section of the first waveguide core is laterally positioned between the first heater and the second heater.

8. The structure of claim 1 further comprising:
a first optical coupler; and
a second optical coupler,
wherein the first section of the first waveguide core and the first section of the second waveguide core extend from the first optical coupler to the second optical coupler.

9. The structure of claim 8 wherein the first section of the second waveguide core overlaps with the first section of the first waveguide core.

10. The structure of claim 9 further comprising:
a heater positioned adjacent to the first section of the second waveguide core.

11. The structure of claim 9 further comprising:
a heater positioned adjacent to the first section of the first waveguide core.

12. The structure of claim 9 wherein the first optical coupler includes a second section of the first waveguide core and a second section of the second waveguide core.

13. The structure of claim 12 further comprising:
a third waveguide core including a first section and a second section, the first section of the third waveguide core overlapping with the second section of the first waveguide core in the first optical coupler,
wherein the second section of the second waveguide core overlaps with the second section of the third waveguide core in the first optical coupler.

14. The structure of claim 1 wherein the first waveguide core includes a second section, and further comprising:
a third waveguide core including a first section and a second section, the first section of the third waveguide core overlapping with the second section of the first waveguide core.

15. The structure of claim 14 wherein the second waveguide core includes a second section, and the second section of the second waveguide core overlaps with the second section of the third waveguide core.

16. The structure of claim 15 wherein the first section of the second waveguide core overlaps with the first section of the first waveguide core.

17. The structure of claim 15 further comprising:
a heater positioned adjacent to the first section of the first waveguide core.

18. The structure of claim 15 further comprising:
a heater positioned adjacent to the first section of the second waveguide core.

19. The structure of claim 1 wherein the first waveguide core comprises a first material, and the second waveguide core comprises a second material different from the first material.

20. A method of forming a structure for a photonic chip, the method comprising:
forming a first waveguide core that includes a section;
forming a dielectric layer;
forming a plurality of air gaps in the dielectric layer; and
forming a second waveguide core that includes a section overlying the section of the first waveguide core,
wherein the dielectric layer is positioned between the first waveguide core and the second waveguide core, and the plurality of air gaps are positioned between the section of the first waveguide core and the section of the second waveguide core.
